(19) United States
(12) Patent Application Publication
(10) Pub. No.: US 2013/0292345 A1
(43) Pub. Date: Nov. 7, 2013

(54) Strainer Apparatus and Method

(71) Applicant: Michelle M. Jones, Baton Rouge, LA (US)

(72) Inventor: Michelle M. Jones, Baton Rouge, LA (US)

(21) Appl. No.: 13/888,765

(22) Filed: May 7, 2013

Related U.S. Application Data
(60) Provisional application No. 61/643,430, filed on May 7, 2012.

(51) Int. Cl. A47J 19/00

(52) U.S. Cl. CPC A47J 19/005
USPC 210/774; 210/483; 210/470; 210/767

(57) ABSTRACT

A strainer assembly has a bowl-like strainer member and a removable container member. The container member can be attached to the base of the strainer member, so that grease or other liquids poured into the strainer assembly will drain into the container member. The grease or other drained liquids can be stored in the container member and allowed to cool prior to disposal or reuse. The strainer member can include an optional handle and spout extension.

### CROSS REFERENCES TO RELATED APPLICATION

PRIORITY OF U.S. PROVISIONAL PATENT APPLICATION SER. NO. 61/643,430, FILED MAY 7, 2012, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to a strainer assembly for separating cooking grease from meat and/or other food items. More particularly, the present invention pertains to a strainer assembly that collects strained grease and/or other liquids from food items for convenient disposal or further handling.

2. Brief Description of the Prior Art

During cooking and food preparation, it is often beneficial to strain certain food items. For example, straining is frequently used to remove undesirable particles from liquids or to separate liquids from solid food items. When food is strained, food items (and typically any related liquids) are poured through a sieve, a perforated utensil such as a conventional colander or a mesh cheesecloth. Typically, the dried food items are retained, while the liquid(s) are saved or stored for later use or disposal.

When strained liquids are substantially water-based, such strained liquids can typically be quickly and easily disposed of, such as by pouring such liquids down a sink drain. However, straining of meat or other items that generate grease can be much more complicated. By way of illustration, but not limitation, grease generally cannot be poured into a sink drain, as such grease can clog pipes and create plumbing issues. Furthermore, hot grease cannot be dumped directly into a conventional garbage can, as said hot grease can melt trash cans, garbage bags and liners.

Thus, there is a need for a safe and efficient means for straining grease and other liquid components from meat and other food items. The strainer means should permit the easy removal of the strained meat or other food items for consumption or further use. Further, said strainer means should permit convenient collection and storage of such grease or other liquids for subsequent disposal or re-use.

### SUMMARY OF THE INVENTION

The present invention comprises a perforated bowl-like strainer member. In the preferred embodiment, said strainer member has a handle member for convenient gripping by a user. Additionally, said strainer member has a spout member, typically disposed substantially on the opposite side of said strainer member from said pouring handle member. A plurality of beneficially sized holes or apertures extends through the base of said strainer member.

The present invention further comprises a container member that can be attached to said bowl-like strainer member. In the preferred embodiment, said container member attaches below the holes or apertures of said strainer member. Meat and/or other solid food items can be poured or otherwise placed into said bowl-like strainer member. Grease and/or other liquids drains from said meat or other solid food items into said container member (which is disposed below the strainer member). Said container member is heat resistant and will not melt when contacted by such grease.

In the preferred embodiment, the strainer member can be beneficially attached (using a mating frictional connection or other quick-connect mechanism) to said container member to permit hands free use. After grease or other liquid has been strained from the meat or other food item, the strainer member can be detached from the container member so that the meat/food can be conveniently consumed or moved to a desired subsequent destination (such as, for example, a pot, pan, dish or storage container). Strained grease can be held in said container member until it is cool enough to dispose of properly. An optional lid or top may be attached to said container member for storage.

The strainer assembly of the present invention has a number of benefits over conventional colanders or strainers. Such benefits include, without limitation, that the strainer assembly of the present invention is free standing, allowing for hands-free use—thereby permitting a user to safely grasp and manipulate a pot, skillet or other cooking vessel with both hands. The strainer assembly also provides a heat resistant container and optional lid member for storing hot grease or other liquids for cooling, eliminating the need to pour such hot grease or other liquids into a sink or garbage can. Further, the strainer and container members are detachably connected with no gaps or spaces between said members, thereby preventing spillage of hot grease or other liquid.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side perspective and partially exploded view of the strainer assembly of the present invention.

FIG. 2 depicts an overhead view of the strainer member of the present invention.

FIG. 3 depicts a side sectional view of the strainer assembly of the present invention.

FIG. 4 depicts a detailed view of the highlighted area in FIG. 3.

FIG. 5 depicts a side perspective and partially exploded view of the container member and optional lid of the present invention.

### DETAILED DESCRIPTION OF A PREFERRED EMBODIMENT

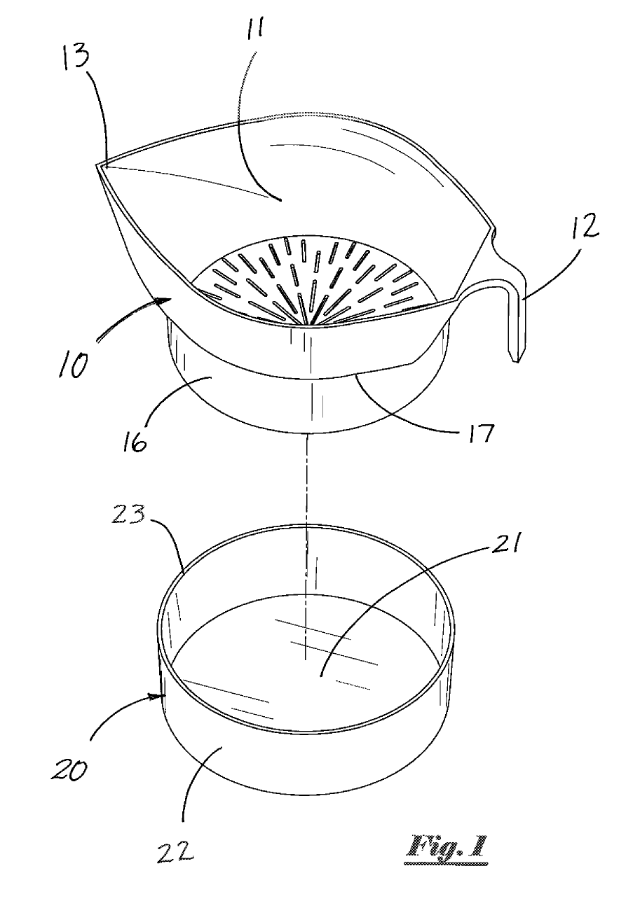

FIG. 1 depicts a side perspective and partially exploded view of strainer assembly of the present invention. Said strainer assembly comprises a perforated bowl-like strainer or colander member 10 defining an inner concave surface 11. In the preferred embodiment, said strainer member 10 also has lower substantially cylindrical base extension 16 and downwardly facing shoulder surface 17.

Strainer member 10 further has a pouring handle member 12 for convenient gripping and pouring by a user. Additionally, said strainer member 10 has a spout member 13, typically disposed substantially on the opposite side of said strainer member 10 from said pouring handle member 12. Pouring handle 12 and spout member 13 allow for greater control when pouring or otherwise emptying said strainer member 10 compared to conventional colanders that must be flipped in order for contents to be emptied.

Still referring to FIG. 1, strainer assembly further comprises a container member 20 that can be attached to strainer member 10. In the preferred embodiment, said container member 20 comprises substantially flat base 21, as well as continuous side wall 22 that surrounds said base 21 and defines a central volume and upper rim 23. As described in detail below, said strainer member 10 and container member 20 can be beneficially temporarily joined during the straining process.

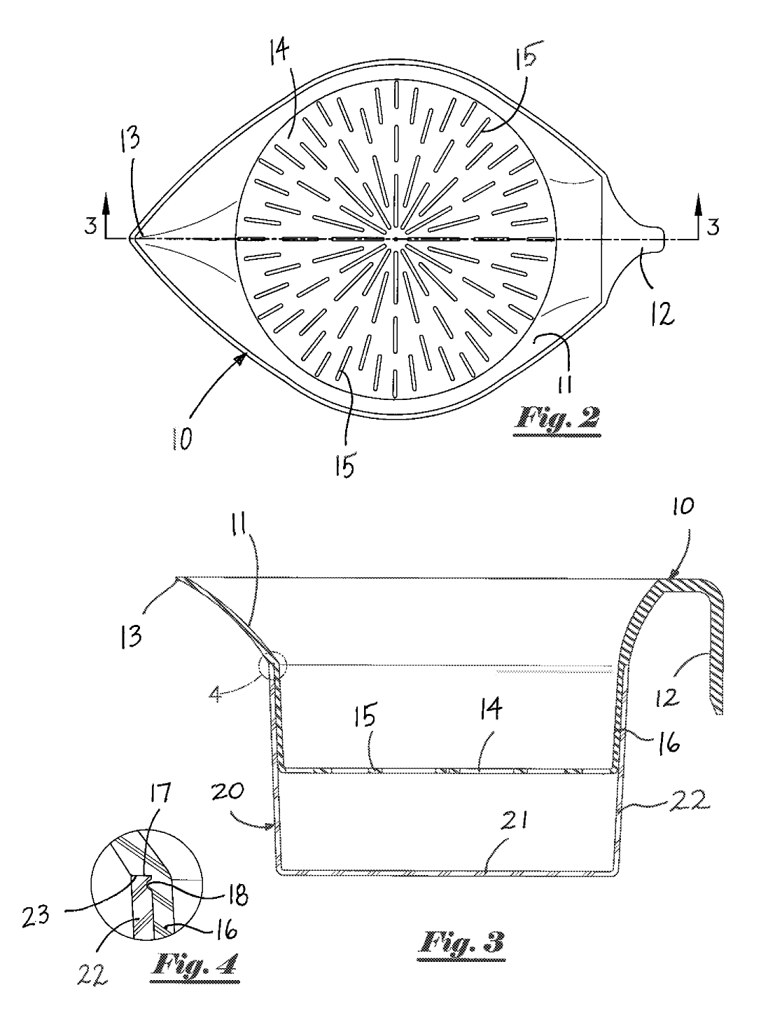

FIG. 2 depicts an overhead view of strainer member 10 of the present invention. Said strainer member 10 defines an inner concave surface 11, as well as pouring handle member 12 and spout member 13. Said pouring handle member 12 and spout member 13 are disposed substantially on the opposite side of strainer member 10 from each other (that is, phased approximately 180 degrees apart around the circumference of said strainer member 10). As noted above, said pouring handle 12 and spout member 13 allow for greater control when pouring or otherwise emptying said strainer member 10 compared to conventional colanders that must be flipped in order for contents to be emptied.

Still referring to FIG. 2, said strainer member 10 has a substantially flat lower surface 14, which permits food placed in said strainer member 10 to spread out and not clump together, thereby improving the draining and drying processes. Said flat lower surface 14 also permits said strainer member 10 to sit on a flat surface without tipping. A plurality of beneficially positioned elongate apertures or slots 15 extends through said substantially flat lower surface 14 of said strainer member 10 to permit drainage of grease or other liquid components through said strainer member 10.

FIG. 3 depicts a side sectional view of the strainer assembly of the present invention. Said strainer member 10 defines an inner concave surface 11, as well as pouring handle member 12 and spout member 13. Said strainer member 10 also has lower substantially cylindrical extension 16 and substantially flat lower surface 14. Elongate apertures or slots 15 extend through said substantially flat lower surface 14 of said strainer member 10.

Strainer member 10 can be beneficially attached (using a mating frictional connection or other quick-connect mechanism) to said container member 20. In the preferred embodiment, a portion of substantially cylindrical lower extension 16 of strainer member 10 can be received within a portion of side wall 22 of container member 20.

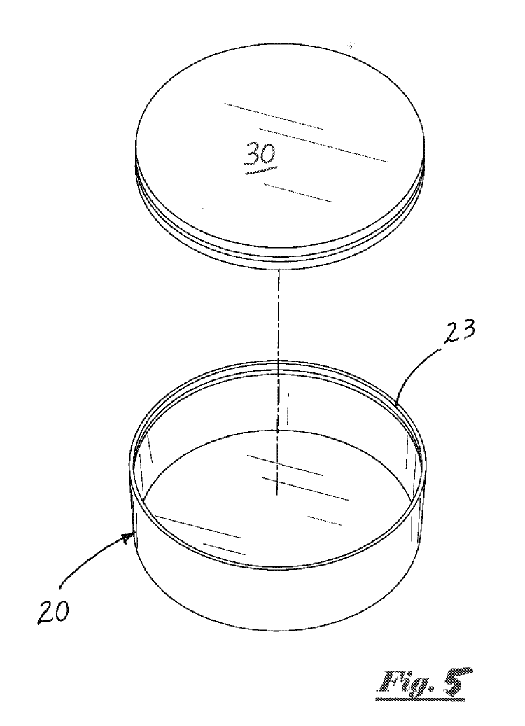

FIG. 4 depicts a detailed view of the highlighted area in FIG. 3. As noted above, a portion of substantially cylindrical lower extension 16 of strainer member 10 can be received within a portion of side wall 22 of container member 20. Shoulder surface 17 of strainer member 10 can rest on upper rim 23 of container member 20. An optional nub 18 disposed on the outer surface of substantially cylindrical extension 16 can be received within a mating recess in side wall 22 of container member 20 for additional temporary “locking” attachment of said strainer member 10 and container member 20.

FIG. 5 depicts a side perspective and partially exploded view of container member 20 and optional lid member 30 of the present invention. Following detachment of strainer member 10 and container member 20, said optional lid member 30 can be placed over upper rim 23 of container member 20 to protect any contents contained or stored within container member 20 and/or to prevent any inadvertent spillage.

In operation, strainer member 10 and container member 20 are temporarily joined as depicted in FIG. 3. Meat and/or other food items can be poured or otherwise placed into bowl-like strainer member 10. Because of substantially flat base 21 of container member 20, the strainer assembly of the present invention is free-standing. As a result, said strainer assembly permits hands-free use, thereby allowing a user to grip a pot, pan or other vessel with both hands when transferring meat or other food item into strainer member 10.

Concave inner surface 11 of strainer member 10 directs such meat and/or other food items toward lower base extension 16 and, ultimately, substantially flat lower surface 14. Said substantially flat lower surface 14 of strainer member 10 permits such meat or other food items to spread out on said flat lower surface 14, thereby reducing clumping and facilitating better drainage and/or drying of such meat or other food items than conventional colanders or strainers having rounded or concave bottoms.

Grease and/or other liquids drains from said meat or other solid food items through elongate slots 15 extending through said substantially flat lower surface 14 into said container member 20 (which is disposed below said strainer member 10). Said elongate slots 15 represent an improvement over conventional round drain holes because said elongate slots prevent small items from plugging said strainer member 10. It is to be observed that said strainer member 10 and container member 20 can be constructed of heat resistant materials to prevent melting when contacted by hot meat, other food items and/or grease.

After grease and/or other liquids have been strained from the meat or other food items, strainer member 10 can be detached from container member 20 so that said meat/food can be conveniently consumed or moved to a desired subsequent destination (such as, for example, a pot, pan, dish or storage container). Pouring handle 12 and spout member 13 of strainer member 10 allow for greater control when pouring or otherwise emptying said strainer member 10 compared to conventional colanders that must be flipped in order for contents to be emptied. Flat lower surface 14 also permits said strainer member 10 to sit on a flat surface (such as a counter top or refrigerator shelf) without tipping.

Strained grease or other liquids remain within container member 20. Said strained grease or other liquids can be held in said container member 20 until said grease is cool enough to dispose of properly. Optional lid member 30 may be attached to said container member 20 during storage (such as, for example, the cooling process).

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An apparatus for draining liquids from solid food items comprising:
a) a strainer member having a base and a plurality of apertures extending through said base; and
b) a container removeably attachable to said strainer member.

2. The apparatus of claim 1, wherein said strainer member further comprising a substantially concave inner surface.

3. The apparatus of claim 1, wherein said apertures comprise elongate slots.

4. The apparatus of claim 1, wherein said base is substantially flat.

5. The apparatus of claim 1, wherein said strainer member further comprises a handle member disposed on one side of said strainer member.

6. The apparatus of claim 1, further comprising a spout member.

7. The strainer assembly of claim 1, further comprising a lid member adapted to be received on said container.

8. The strainer assembly of claim 1, wherein said strainer member and said container are constructed of heat resistant material.

9. An apparatus for draining liquids from solid food items comprising:
a) a strainer member comprising:
i) a substantially concave inner surface;
ii) a substantially cylindrical extension disposed below said substantially concave inner surface;
iii) a substantially fiat base disposed near the bottom of said substantially cylindrical extension;
b) a container having a substantially flat bottom, wherein said container is removeably attachable to said strainer member, and said container is at least partially disposed beneath said base of said strainer member.

10. The apparatus of claim 9, wherein said strainer member further comprises:
a) a handle member disposed on a side of said strainer member; and
b) a spout member disposed on a side of said strainer member.

11. The apparatus of claim 9, wherein said handle member and said spout are disposed on opposite sides of said strainer member from each other.

12. The apparatus of claim 9, further comprising a lid member adapted to be received on said container.

13. A method of straining grease from meat comprising:
a) pouring said meat into a strainer assembly comprising:
i) a strainer member having a base and a plurality of apertures extending through said base;
ii) a container removeably attachable to said strainer member; and
b) draining said grease from said meat through said strainer member into said container.

14. The method of claim 13, further comprising removing said strainer member from said container.

15. The method of claim 13, further comprising pouring said meat from said strainer member to a vessel.

16. The method of claim 14, further comprising placing a lid on said container member.

17. The method of claim 14, further comprising cooling said grease in said container.

18. The method of claim 17, further comprising disposing of said cooled grease.
